(19) United States
(12) Patent Application Publication
(10) Pub. No.: US 2024/0142804 A1
(43) Pub. Date: May 2, 2024

(54) Integrated Programmable Strongly Coupled Three-Ring Resonator Photonic Molecule with Ultralow-Power Piezoelectric Control

(71) Applicant: The Regents of the University of California, Oakland, CA (US)

(72) Inventors: Daniel J. Blumenthal, Santa Barbara, CA (US); Jiawei Wang, Goleta, CA (US)

(73) Assignee: The Regents of the University of California, Oakland, CA (US)

(21) Appl. No.: 18/500,008

(22) Filed: Nov. 1, 2023

Related U.S. Application Data
(60) Provisional application No. 63/381,811, filed on Nov. 1, 2022.

(51) Int. Cl. G02F 1/01; G02B 6/293

(52) U.S. Cl. CPC G02F 1/0113; G02B 6/29338; G02F 2203/15

(57) ABSTRACT

A Photonic molecule may include a first ring resonator that is tunable by a first piezoelectric actuator. A Photonic molecule may include a second ring resonator that is tunable by a second piezoelectric actuator, wherein the second ring resonator optically coupled to the first ring resonator. A Photonic molecule may include a third ring resonator that is tunable by a third piezoelectric actuator, wherein the third ring resonator is optically coupled to the first ring resonator and the second ring resonator. A Photonic molecule may include a waveguide optically coupled to the first ring resonator.

### CROSS-REFERENCE TO RELATED APPLICATIONS

The current application claims the benefit of and priority under 35 U.S.C. § 119(e) to U.S. Provisional Patent Application No. 63/381,811 filed Nov. 1, 2022, entitled “Non-Magnetic Ultra-Low Loss Waveguide Integrated Optical Isolator/Circulator and Self-Isolating Laser,” the disclosure of which is incorporated herein by reference in its entirety for all purposes.

### STATEMENT OF FEDERAL SUPPORT

This invention was made with government support under 1745612 awarded by the National Science Foundation. The government has certain rights in the invention.

### FIELD OF THE INVENTION

The present invention generally relates to integrated optical isolators, circulators, lasers, programmable dispersion engineering and/or programmable resonances. It is more particularly related to non-magnetic ultra-low loss waveguide integrated optical isolators, circulators, self-isolating lasers enabling systems for dispersion engineering and related applications and/or devices such as optical parametric oscillators, optical frequency combs, and/or other nonlinear devices and/or functions.

### BACKGROUND

Modulation-based control and locking of lasers, filters and/or other photonic components is a common function across many applications that span the visible to infrared (IR) spectrum. These can include atomic, molecular and optical (AMO), quantum sciences, fiber communications, metrology, and/or microwave photonics. Today, modulators used to realize these control functions often consist of high-power bulk-optic components for tuning, sideband modulation, and phase and frequency shifting. They can often provide low optical insertion loss and operation from DC to 10s of MHz.

Optical isolators (also called optical diodes) are optical components that transmit light in only one direction. Isolators can be used to prevent unwanted reflections from entering back into a device such as a laser. They are often used with lasers to prevent unwanted feedback into associated laser cavities. Typical optical isolators typically include faraday rotators or other magnet-based components or current wire-based magnetic coils. The use of faraday rotators relies on magneto-optic effects. Optical isolators are non-reciprocal optics, where the loss in the forward direction is very low for a wavelength or optical signal, and loss for that same wavelength or signal is very high propagating backward, realizing isolation between the output back to the input. Magnetic field, magnetic, and magneto-optic based devices are not favorable for integration for many reasons including increase complexity, power consumption, incompatibility with wafer-scale CMOS foundry compatible processes, and introduction of unwanted magnetic fields around optical, photonic, and electrical devices.

Optical circulators are three-port optical components which can receive light through a first port and output the light through a second port while preventing light from the second port propagating back to the first port, instead allowing the light to propagate from the second port to a third (circulator) port. In other words, the circulator plays the role of an optical isolator between the input first port and the second port but provides a low loss connection from the second to the third port. Optical circulators have the property that reflected light input to the second port exits through a third port and not the first port. In other words, the loss is very low for light at a wavelength entering the second port and exiting the third circulator port, whereas the optical loss is very high for that light entering the second port to the first port. Optical circulators are non-reciprocal optics. Non-reciprocal optics have the property that changes to light passing through the non-reciprocal optic in a first direction cannot be reversed by passing the light through the non-reciprocal optic in the opposite direction. Typically, optical circulators rely on external magnetic fields or magnetic based effects such as the magneto-optic effect. Optical circulators, like optical isolators, often rely on faraday rotators.

### SUMMARY OF THE INVENTION

In an embodiment a photonic molecule can be configured as a programmable tunable dispersion engineering system. In an embodiments, the photonic molecule including: a first ring resonator optically coupled to a first waveguide, wherein the first ring resonator is tunable by a first piezoelectric actuator; a second ring resonator optically coupled to a second waveguide, wherein the second ring resonator is tunable by a second piezoelectric actuator; a third ring resonator optically coupled to a third waveguide, wherein the third ring resonator is tunable by a third piezoelectric actuator; and wherein the third ring resonator is optically coupled to the first ring resonator and the second ring resonator, wherein the second ring resonator is optically coupled to the first ring resonator and the first ring resonator, and wherein the first ring resonator is optically coupled to the second ring resonator and the third ring resonator.

In another embodiment, each of the first, second, and third ring resonators are independently controllable by separately applying a first voltage to the first piezoelectric actuator, a second voltage to the second piezoelectric actuator and a third voltage to the third piezoelectric actuator.

In another further embodiment, at least one of the first, second, and third piezoelectric actuators is a lead zirconate titanate stress-optic actuator.

In yet another embodiment, the first, second, and third ring resonators are positioned at a regular spacing of around 120 degrees.

In still another embodiment again, the first piezoelectric actuator, second piezoelectric actuator, and third piezoelectric actuator all allow DC bias resonance tuning of the first ring resonator, second ring resonator, and third ring resonator respectively.

In another further embodiment, the first piezoelectric actuator allows radio frequency modulation of the first ring resonator, the second piezoelectric actuator allows radiofrequency modulation of the second ring resonator, and the first piezoelectric actuator allows radiofrequency modulation of the third ring resonator.

In yet still another embodiment, there is a fixed phase relationship between the modulation of the first ring resonator, the second ring resonator, and the third ring resonator.

In yet another embodiment again, the fixed phase relationship is an around 120 degree phase shift between each pair of ring resonators.

In yet still another further embodiment, the photonic molecule further includes a third waveguide optically coupled to the third ring resonator, and wherein the third waveguide includes a fourth port.

In another additional embodiment, each of the ring resonators are equally spaced from each other, and wherein the spacing between each waveguide and each ring resonator is a same amount.

In yet another additional embodiment, a radiofrequency (RF) modulation can be applied to all three piezoelectric actuators to produce a spatio-temporal modulation of the ring resonators that is decoupled from physical dimensions of each ring resonator.

Numerous embodiments can include a non-magnetic ultra-low loss waveguide integrated optical isolator and circulator. In an embodiment, the optical isolator circulator including: a set of ring resonators, wherein each ring resonator from the set of ring resonators is optically coupled to a waveguide and each ring resonator is optically coupled to at least two other ring resonators from the set of ring resonators, and wherein the set of ring resonators includes at least a first ring resonator, a second ring resonator, and a third ring resonator; a set of piezoelectric actuators, wherein each ring resonator in the set of ring resonators corresponds to a piezoelectric actuator from the set of piezoelectric actuators on a one-to-on basis, and wherein the set of piezoelectric actuators is configured to tune each of the ring resonators from the set of ring resonators independently; a signal source electrically connected to each piezoelectric actuator in the set of piezoelectric actuators, the signal source configured to provide a modulating radio frequency input to each piezoelectric actuator in the set of piezoelectric actuators such that a first piezoelectric actuator receives a first modulating radio frequency input, the second piezoelectric actuator receives a second modulating radio frequency input, and the third piezoelectric actuator receives a third modulating radio frequency input; and wherein the second modulating radio frequency input is offset from the first modulating radio frequency input by a first amount, the third modulating radio frequency input is offset from the first modulating radio frequency by a second amount, and the second amount is around double the first amount; wherein the first amount is equal to around 360 degrees divided by a total number of ring resonators in the set of ring resonators.

In a further embodiment, the ring resonators are positioned at a regular spacing equal to around 360 degrees divided by the total number of ring resonators in the set of ring resonators.

In a yet further embodiment, each of the ring resonators is configured to be DC bias resonance tuned.

In a still further embodiment, the piezoelectric actuators are zirconate titanate stress-optic actuators.

In a further embodiment again, the first, second, and third ring resonators are positioned at a regular spacing of around 120 degrees.

In still yet a further embodiment, a radiofrequency (RF) modulation applied to the piezoelectric actuators produces a spatio-temporal modulation of the ring resonators that is decoupled from physical dimensions of each ring resonator.

In yet a further embodiment again, the first waveguide, the first ring resonator, the second ring resonator, the third ring resonator, and the second waveguide are mounted in a fully planar platform.

Several embodiments can include a self-isolating laser. In an embodiment, the self-isolating laser including: a laser source connected to a first port on a first waveguide, the first waveguide including the first port and a second port; a first ring resonator optically coupled to the first waveguide, wherein the first ring resonator is tunable by a first piezoelectric actuator; a second ring resonator optically coupled to a second waveguide, wherein the second ring resonator is tunable by a second piezoelectric actuator; a third ring resonator optically coupled to a third waveguide, wherein the third ring resonator is tunable by a third piezoelectric actuator; and wherein the third ring resonator is optically coupled to the first ring resonator and the second ring resonator, wherein the second ring resonator is optically coupled to the first ring resonator and the first ring resonator, and wherein the first ring resonator is optically coupled to the second ring resonator and the third ring resonator.

In an additional embodiment, the techniques described herein relate to a self-isolating laser, wherein the first ring resonator, second ring resonator, and third ring resonator are modulated by a radiofrequency and there is a fixed phase relationship between the modulation of the first ring resonator, the second ring resonator, and the third ring resonator.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The description and claims will be more fully understood with reference to the following figures and data graphs, which are presented as exemplary embodiments of the invention and should not be construed as a complete recitation of the scope of the invention.

FIG. 1 conceptually illustrates an example of a strongly coupled three-ring resonator photonic molecule.

FIGS. 2A through 2B conceptually illustrate an example photonic molecule made up of three fully coupled tunable ring resonators.

FIG. 3 conceptually illustrates an example of a resonator ring and a waveguide.

FIG. 4A conceptually illustrates an example data set corresponding to a single ring resonator with PZT actuator.

FIG. 4B conceptually illustrates an example data set corresponding to a single ring resonator without PZT actuator.

FIG. 5 conceptually illustrates a photonic molecule with three ring resonators.

FIGS. 6A through 6C conceptually illustrate transmission spectrums related to three mode-splitting cases of photonic molecules.

FIGS. 7A through 7C conceptually illustrate example transmission spectrums of ring resonators that together form a part of a photonic molecule when tuned by PZT actuators with applied DC bias.

FIG. 7D depicts a corresponding frequency response of a photonic molecule with tuned and untuned ring resonators.

FIG. 8 conceptually illustrates an example of a photonic molecule with radiofrequency driving.

FIGS. 9A through 9D conceptually illustrate an example effect of modulating RF frequency applied to a three-ring resonator photonic molecule.

FIGS. 10A through 10B conceptually illustrate an example of a self-isolating laser.

FIG. 11 conceptually illustrates an example of a self-isolating laser incorporating a combiner.

### DETAILED DESCRIPTION

In accordance with many embodiments of the invention, integrated three-ring resonators can form photonic molecules. Photonic molecules, as discussed herein, can refer to electromagnetically-interacting optical cavities (e.g., microcavities). Photonic molecules can realize complex optical energy modes that simulate states of matter and have application to quantum, linear, and nonlinear optical systems.

Photonic molecules can be configured with flexible, controllable, stable, high-resolution energy states using low power tuning mechanisms in accordance with many embodiments of the invention. In some embodiments, photonic molecules can be controllable, silicon nitride integrated photonic molecules, with three high-quality factor ring resonators strongly coupled to each other. Coupled ring-resonators forming photonic molecules can be individually actuated using ultralow-power tuning. Ultralow-power tuning can be performed by thin-film lead zirconate titanate (PZT) actuators.

Photonic molecules can be systems of coupled optical resonators that produce rich quantized energy states and/or supermodes with behavior analogous to atoms and molecules. These characteristics can enable precision control of light and light-matter interactions including complex dispersion engineering, nonlinear energy-level transitions, applications including many-body physics simulations, and/or quantum optical phenomena. Photonic molecules can enable nonlinear functions through nonlinearities and dispersion engineering, such as optical parametric oscillation and optical frequency comb generation.

In some embodiments, photonic molecules can be capable of using three coupled ring-bus resonators. The use of three coupled ring-bus resonators can result in six tunable supermodes. Each of the ring resonators can be fully controlled, including their degeneracy, location, and degree of splitting. PZT actuator design, in accordance with many embodiments of the invention, can yield narrow photonic molecule energy state linewidths below 58 MHz without degradation as the resonance shifts, with over an order of magnitude improvement in resonance splitting-to-width ratio of around 58, power consumption of 90 nW per actuator, and/or a 1-dB photonic molecule loss. The preservation of the resonance width is achieved by using modulation and actuation that does not appreciable adversely affect the waveguide loss and resonator Q. PZT modulators are one type of actuator that allows DC tuning and radio-frequency (RF) modulation in the kHz, MHz, 10s MHz, 100s MHz, GHz and higher regime without affecting wavelength loss and resonator Q. DC tuning allows the resonators to be aligned or to program state splitting, resonance location, and engineering dispersion. RF modulation of the ring resonators enables many desirable features including spatio-temporal modulation of the ring indices of refraction, where each ring can be independently modulated or modulated with a fixed phase relationship between the ring resonators. Strongly coupled PZT-controlled high-Q resonators can provide a high-degree of resolution and controllability in accessing associated supermodes.

In many embodiments, the low loss of the silicon nitride platform from the visible to infrared spectrum, the three individual bus design, and/or the multi-port (e.g., six port) design, can beneficially enable novel device designs and a wide range of applications. The low waveguide loss can extend down to the UV and deep UV by using other integration materials for the waveguides and ring resonators such as aluminum oxide, tantalum pentoxide, and/or aluminum nitride in accordance with many embodiments of the invention. The low waveguide loss and embodiments can also be moved to the near-IR, mid-IR and IR using silicon nitride and/or other appropriate low loss waveguide materials in various embodiments. Applications can include at least tunable lasers, high-order suppression ultranarrow-linewidth lasers, dispersion engineering, optical parametric oscillators, optical frequency combs, physics simulations, atomic photonics, and/or quantum photonics.

Optical isolation of lasers and other photonic devices, subsystems and systems, can be beneficial since the lasers, other optical and/or photonic components are often sensitive to optical feedback from external elements that the lasers and/or optical elements are connected to. Traditional, discrete component optical isolators are bulky, costly, and difficult to manufacture, particularly when operating in the visible wavelengths, and contain magnetic materials which can be costly and/or can interfere with operation of other application functions.

Optical isolators for visible light, near IR and mid IR, and UV, can be utilized in a wide variety of applications including quantum, atomic clocks and navigation, precision metrology. Today, these applications utilize optical components that dominate the size, cost, complexity, and manufacturing difficulty of optical systems used to realize these applications.

While optical isolators functioning at other wavelengths, for example the telecommunications C-Band (1550 nm) or O-Band (1310 nm) can bring these advantages to fiber communications, data centers, fiber sensing, and frequency and time transfer as well as other applications. Additionally, isolators that can also be used as circulators provide the benefit of routing light that is isolated to another port usable for other parts in the circuit.

Various embodiments of the invention can include a novel three-port, three coupled ring, optical resonator structure that, when driven with an RF signal, provides ultra-low optical loss, non-magnetic isolation using low-power stress-optic actuators, and/or that is compatible with an established ultra-low loss, CMOS compatible, wafer scale, silicon nitride photonic integrated platform. In some embodiments, each of the rings may include two ports. Thus, in the three coupled ring design there can be 6 ports with one bus per ring. In several embodiments, photonic molecules can have three or more to make various different configurations. In some embodiments, one primary use port may be connected to a laser output, one primary use port can be connected to the output where the light goes, and/or a third primary use port may be a circulator port where reflected light can be accessed.

In some embodiments, an isolator can also act as a circulator. A structure can be used as the output mirror of a tunable laser, providing the laser cavity and three port isolation/circulation for a self-isolating laser cavity. For example, one configuration is where the isolator is the mirror for a laser device and where there is another mirror and a gain medium in the laser device.

In one configuration, an isolator can connect with feedback directly to the connection port, and/or can be configured to connection with the laser using a coupler. An isolator can include 6 ports, which may be utilized for other configurations. Another configuration is as a self-injection locked laser where there is a laser source attached to the isolator and it provides feedback to the laser to injection lock the laser. In both cases, as a mirror or as a cavity for injection locking, the isolator can serve to prevent unwanted outside feedback.

Photonic integration has made great progress towards integration of visible light and infrared photonics applications at the chip-scale. However, optical isolation has not previously been successfully realized in photonic integrated form, particularly in a way that is compatible with large scale, CMOS compatible, high performance photonic circuits.

Legacy systems have included dual cavity, controllable, waveguide resonators capable of nonlinear 2-level transitions, symmetry breaking optical isolation, soliton optical frequency comb generation, dispersion engineering, and/or squeezed state sources. Several photonic molecule energy state tuning mechanisms have been demonstrated in legacy systems including thermal, electro-optic, mechanical, optical, and acousto-optic.

Photonic integration of isolators exists that utilize magnetic structures, for example magnetic materials or current loops. Typically, these systems are not integration compatible and/or they create unwanted magnetic fields. The magnetic material is applied at the back end of the fabrication process which takes up space, time and processing complexity. This can increase the assembly costs and/or lower the production yield. Some circuits use current loops to produce the magnetic field for magnetic isolators and these can introduce potentially unwanted magnetic fields. Thus, isolators incorporating magnetic material may be undesirable for CMOS wafer-scale compatible processes.

Other previous solutions use optical nonlinearities and/or spatial-temporal modulation that does not have good isolation, is not low loss, and/or has other undesirable attributes such as requiring high electrical or optical power. Undesirable attributes can include characteristics such as having very high frequency electrical signals that are tied to the isolator design and cannot be chosen independently and operated at low cost, low power, and lower electrical frequencies. Other undesirable attributes include designs that do not translate readily to other wavelengths and other integration material systems. Further undesirable attributes include designs that affect the optical loss and the optical cavity Q and the optical resonance widths.

Therefore, non-magnetic optical isolators with beneficial attributes like low-loss and ease of integration, as well as operation using low frequency electronic signals and simple electronics (such as those described herein in connection with various embodiments) may be beneficial. In several embodiments of the invention, optical isolators are non-magnetic, compact, low cost and can be integrated using photonic integrated, CMOS wafer-scale compatible processes.

### Three Ring Resonator Photonic Molecules

In several embodiments, a photonic molecule can be monolithically integrated, programmable and/or include three strongly coupled ring resonators. Programmability of the ring resonators can, in several embodiments, be based on electrical biasing of piezoelectric (e.g., PZT) actuators. Photonic molecules can include three ring resonators made with silicon nitride. In accordance with many embodiments, three ring resonators can have intrinsic Q of around 8.11 million. Each of the ring resonators can be a piezoelectrically controlled integrated ring resonator.

In accordance with many embodiments of the invention, the ability to maintain high Q via piezoelectric (e.g., PZT) actuation without degradation as the resonance shifts can result in narrow PM resonance linewidths that are independent of the tuning and state splitting. Several embodiments can include photonic molecules with resonance splitting to a linewidth ratio of around 58. This linewidth ratio can correspond to the lowest known linewidth for a PZT tunable resonator and over an order of magnitude improvement in resonance split to linewidth ratio as compared with prior integrated three-resonator photonic molecules. In many embodiments, PZT actuators can offer 90-nW ultralow-power dissipation with a linear tuning coefficient of 160 MHz/V. The devices can, in accordance with many embodiments, can be capable of fabrication with a CMOS foundry compatible process without requiring complex processes like under-cut, released and/or suspended structures. Using PZT actuation can remove the need for manufacturing processes like under-cut, released and/or suspended structures since the PZT actuated structure can be monolithically planar.

In accordance with embodiments of the invention, PZT actuation can provide a programmable photonic molecule platform that increases the design and spectral flexibility of the system. This can enable scaling the system to larger arrays since PZT actuated photonic molecules can offer low power and compact size.

In accordance with many embodiments of the invention, multiple discrete levels of the photonic molecule can be used as a signal splitter and/or a wavelength shifter with proper PZT spatiotemporal modulation. Photonic molecules, as described herein can enable new integrated circuits for tunable dispersion compensators, optical frequency comb generation, and/or optical parametric oscillation by tuning the phase-matched modes.

Photonic molecules can be integrated, in several embodiments, for applications including, but not limited to, multichannel high-order filters, topological photonics, ultralow phase noise lasers through higher-order mode inhibition of stimulated Brillouin lasers through mode splitting, and/or many-body physics simulations. The low power consumption afforded by PZT actuation can beneficially enable large-scale integration of coupled photonic atoms and complex photonic molecules on a chip. Furthermore, applications of PZT actuation can be suited for heterogeneous integration with semiconductor lasers.

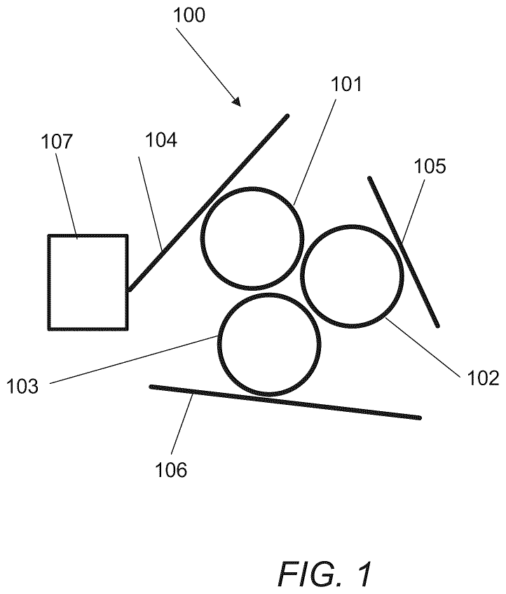

An example of a strongly coupled three-ring resonator photonic molecule is conceptually illustrated in FIG. 1. A photonic molecule 100 can include a first ring resonator 101, second ring resonator 102, and a third ring resonator 103. The first ring resonator 101 can be strongly optically coupled to the second ring resonator 102 and the third ring resonator 103. The second ring resonator 102 can be strongly optically coupled to the third ring resonator 103 and the first ring resonator 101. The third ring resonator 103 can be strongly coupled to the first ring resonator 101 and the second ring resonator 102. In several embodiments, ring resonators of a photonic molecule can be positioned at a regular spacing of around 120 degrees. The first ring resonator 101 can optically coupled to a first waveguide 104. Optionally, the second ring resonator 102 can be optically coupled to a second waveguide 105. Optionally, the third ring resonator 103 can be optically coupled to a third waveguide 106. Hence, in several embodiments, each of the ring resonators of a photonic molecule are coupled to a different waveguide. Waveguides coupled to ring resonators can have ports (e.g., through-ports). In various embodiments, each of the waveguides can have a first port and a second port.

In accordance with many embodiments, a photonic molecule can be functional as an optical isolator when it includes at least a first waveguide with a first and second port, the first waveguide coupled to a first ring resonator. Light entering the first port can exit the second port with all reflections towards the first port attenuated by the three-ring structure of the photonic molecule.

In several embodiments a photonic molecule functioning as an optical isolator can include a first waveguide and a second waveguide, the first waveguide coupled to a first ring resonator, and the second waveguide coupled to a second being resonator. Light entering the first port can exit the second port with all reflections in the first waveguide towards the first port attenuated by the three-ring structure. In this arrangement light can exit the second port of the first waveguide, and can also exit the second waveguide.

In several embodiments, a photonic molecule can be suitable as a circulator when it includes at least a first waveguide and a second waveguide, each of the first and second waveguides having first and second ports.

In many embodiments, a photonic molecule can form part of a self-isolating laser. With regards to FIG. 1, the photonic molecule 100 can be connected to an optional laser source 107. In accordance with embodiments of the invention, a laser source can be a laser gain chip. The laser source 107 can be coupled to first waveguide 104. Self-isolating lasers can include laser gain chips and other passive components such as optical splitters, combiners, phase tuning elements and/or intensity tuning elements coupled to one or more waveguide ports of photonic molecules. Photonic molecules as described herein can function as optical isolators, optical circulators, and/or as self-isolating lasers.

In accordance with various embodiments of the invention, photonic molecules can be suitable for fabrication in a wafer-scale CMOS foundry compatible photonic integration platform. Photonic molecules can, in several embodiments, be produced in a fully planar fabrication process of low-loss waveguides and high-quality factor (Q) coupled ring resonators. In many embodiments, ring resonators can be independently tuned with low-power actuation that maintains low loss and high Q. In many embodiments, photonic molecules can enable applications including tunable lasers, dispersion engineering, nonlinear frequency synthesis, analog optical computation, quantum photonic circuits, and/or physics simulations.

In accordance with many embodiments of the invention, three ring resonator photonic molecules can be configured to enable DC bias resonance tuning of each ring resonator independently. Bias resonance tuning can, in many embodiments, be performed using low-power actuators (e.g., PZT actuators). In many embodiments, actuators can suitable for modulation in the MHz to GHz range. Actuators can be piezoelectric materials such as lead zirconate titanate (PZT), and/or aluminum nitride (AlN). Throughout this specification, actuators may often be referred to as being made from PZT, it is however understood, that in various embodiments, different piezoelectric materials can also be used. Low-power actuators can be PZT stress-optic actuators in accordance with many embodiments of the invention.

PZT stress-optic actuators, in accordance with embodiments of the invention can be capable of maintaining low optical waveguide losses and high optical Q with static (DC) tuning capabilities and/or AC modulation, while offering low cross talk. In many embodiments, PZT stress-optic actuators allow fully planar, ultralow-loss platforms. Using PZT can make it unnecessary to use under-etching processes while maintaining low optical losses across the visible to IR spectrum.

In accordance with many embodiments, photonic molecules can have insertion losses of around 1 dB from a through port, with a coupling loss measured with a straight waveguide to be 5 dB from double sides.

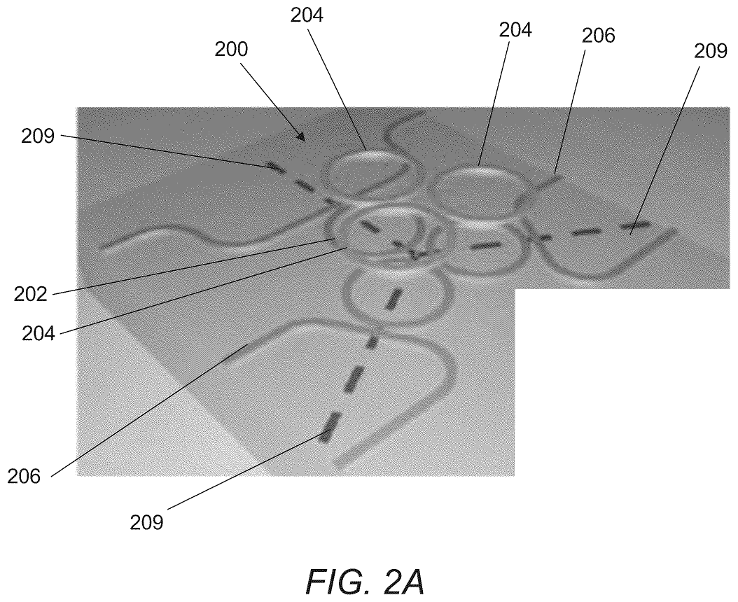

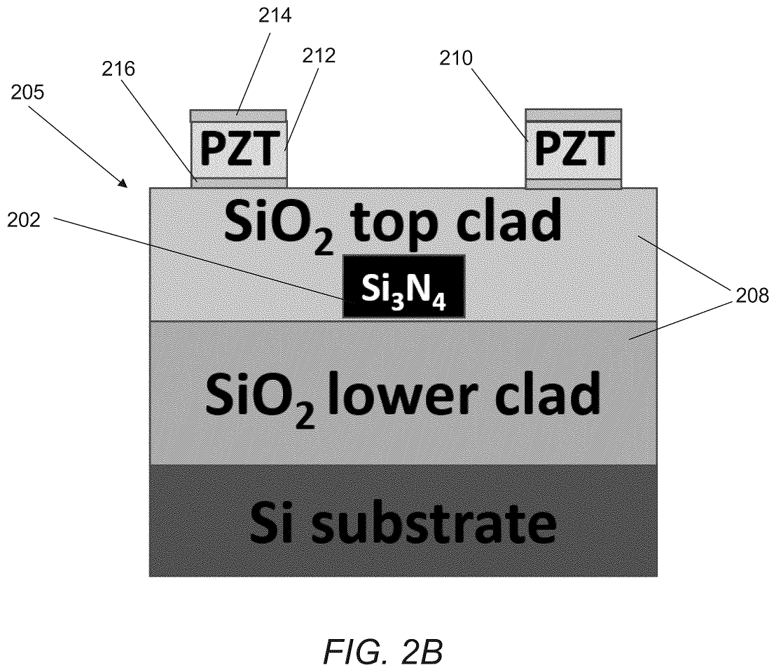

An example photonic molecule made up of three fully coupled all-waveguide, piezoelectric tunable ring resonators is conceptually illustrated in FIG. 2 in accordance with an embodiment of the invention. The photonic molecule 200 includes three ring resonators 202. The ring resonators 202 may be silicon nitride. The ring resonators 202 are piezoelectric tunable by piezoelectric actuators 204. In accordance with many embodiments of the invention, piezoelectric actuators are stress-optic actuators. The piezoelectric actuators 204 may be piezoelectric rings (e.g. PZT rings). The piezoelectric actuators 204 are located offset from the ring resonators 202. Each combined structure of ring resonator 202 and piezoelectric actuators 204 can be referred to as a piezoelectric tunable ring resonator. Each of the ring resonators 202 are optically coupled to the other two ring resonators 202. Each ring resonator 202 is further optically coupled to a waveguide 206. Each of the waveguides 206 are optically coupled to only one of the ring resonators 202. Each of the waveguides 206 and ring resonators 202 can each be made of Si₃N₄ embedded in a cladding 208 of SiO₂. As illustrated in FIG. 2A, the piezoelectric actuators 204 may be directly overlapping the ring resonators 202. In several embodiments, ring resonators and waveguides can be formed of Si₃N₄. The three ring resonators 202 can be symmetric to three-axes 209 angled at 120-degrees offset.

In some examples, the piezoelectric actuators 204 may be offset from the ring resonators 202. A cross-section of a PZT tunable ring resonator is conceptually illustrated in FIG. 2B in accordance with an embodiment of the invention. The ring resonator 202 (e.g., a Si₃N₄ ring resonator) is embedded in a cladding 208 of SiO₂. SiO₂ can be disposed on both the top and bottom of the ring resonator 202. piezoelectric actuator 204 can be disposed on the opposite side of the top cladding 208 of the ring resonator 202. In several embodiments, ring resonators can be ring-bus resonators. The piezoelectric actuator 204 can include an inner ring portion 210 and an outer ring portion 212. The piezoelectric actuator 204 can be sized and arranged such that they do not overlap and are offset from the ring resonator 202. In several embodiments, piezoelectric (e.g., PZT) actuators can be laterally offset from a ring resonator by around 2 μm. In many embodiments, an inner ring portion and an outer portion of a piezoelectric actuator (e.g., PZT actuator) can be offset to either side of the ring resonator. The offset amount can be around 2 μm. The piezoelectric actuators 204 can include a top electrode 214 and a bottom electrode 216. The depicted photonic molecule 200 can include three coupled ring resonators 202 arrange symmetric to the three-axes angled at 120-degrees offset as indicated by dotted lines. In accordance with several embodiments, photonic molecules can include three ring resonators or another number. In several embodiments, each ring resonator in a photonic molecule can have the same radii. The ring resonators can be symmetrically positioned relative axis of symmetry equal to the number of photonic molecules. In other words, when there are three ring resonators there are also three lines of symmetry. Similarly, four axis of symmetry when the photonic molecule has four ring resonators, and so one for other numbers of ring resonators. In many embodiments, all inter-ring (e.g., gaps between ring resonators) gaps may be equal, and/or all ring-bus waveguide gaps may also be equal.

Examples of offset piezoelectric actuators are described in U.S. patent application Ser. No. 18/485,173, entitled “Stress Optic Tuners for Waveguide-Based Devices” and filed Oct. 11, 2023, which is hereby incorporated by reference in its entirety for all purposes.

In accordance with many embodiments, photonic molecules can include three fully coupled ring resonators. Ring resonators can be all-waveguide silicon nitride high-Q, PZT tunable ring resonators. Each of the three ring resonators can be strongly coupled to each other and/or can have its own independent waveguide. Static tuning and narrow linewidth modes of the ring resonators can be realized using monolithically integrated, ultralow-power dissipation PZT actuators. PZT actuators can be compatible with silicon nitride platforms and can maintain high resonator Q.

In some embodiments, ring resonators can be 580-μm radius silicon nitride ring resonators. Photonic molecules can, in many embodiments, include three such ring resonators, all of which are strongly optically coupled to each other. Such photonic molecules can have an around 43-MHz full width at half maximum (FWHM) resonance width and/or an around 48-GHz free spectral range (FSR). In several embodiments, the performance achieved with a single ring resonator (among the three included in a photonic molecule as described herein), can be an intrinsic Q of around 8.11 million measured at 1550 nm.

In accordance with many embodiments, photonic molecules can exhibit high-resolution supermode splitting. High-resolution supermode splitting can be due to the strong coupling between the high-Q ring resonators. Supermode splitting can be tuned by 2.5 GHz with a 0-15-V DC applied voltage while maintaining the narrow linewidth below 58 MHz across the full tuning range with a tuning sensitivity of 160 MHz/V. In many embodiments, tuning can be performed by piezoelectric actuators. Piezoelectric actuators can be PZT actuators. PZT actuators can have low power consumption of around 90 nW per PZT actuator. In several embodiments, a large mode splitting to linewidth ratio of 58 can be achieved with PZT actuated photonic molecules as described herein. High-resolution supermode splitting can be enabled by low optical losses and high resonator Q that are preserved by the bias and modulation actuators. High resolution supermode splitting can enable precision tuning, dispersion engineering, and/or other benefits for linear optical systems. High resolution supermode splitting can further enable optical isolation, and/or optical circulation. Optical nonlinearities such as optical parametric oscillation, parametric conversion, nonlinear optical signal generation, and/or optical frequency combs can be enabled by high resolution supermode splitting. In accordance with various embodiments, supermode splitting can be performed by modulation (e.g., RF modulation) as described elsewhere herein.

In accordance with embodiments of the invention, coupled mode theory (CMT) matrix models can be used to accurately simulate and predict resonance tuning and splitting of PZT tunable ring resonators. Such modeling methods have shown excellent agreement with experimental measurements. Such a model can provide a robust tool for photonic molecule device design. Modelling can enable control of photonic molecules for integrated photonic applications including photonic molecule combs and photonic molecule quantum photonics.

Photonic molecules (e.g., photonic molecule 200) can include three coupled ring-bus resonators symmetric to three-axes angled at 120-degrees offset. As depicted in FIG. 2B, photonic molecules, in accordance with embodiments of the invention can include waveguides and actuator structures that are fully planar monolithic structures. This can beneficially mean that undercut and/or released tuning structures and/or waveguides are not required.

In several embodiments, resonator rings can have a 580-μm radius with 1.5-μm ring-bus coupling gap. Waveguide geometry can include 175 nm thickness and/or 2.2 μm width. Piezoelectric (e.g., PZT) actuators can have with a 2-μm horizontal offset from a corresponding ring resonator. The corresponding ring resonator can refer to the ring resonator that is capable of being actuated by the piezoelectric actuator. In several embodiments, a piezoelectric actuator can be formed of two concentric rings. Each of the two concentric rings can be offset from an underlying ring resonator. The offset amount can be around 2-μm from a centerline of the ring resonator. In accordance with embodiments of the invention, the gap can be large enough for the piezoelectric actuator to be completely offset from a ring resonator such that no perpendicular line extending from a plane of the ring resonator intersects both the ring resonator and the piezoelectric actuator. Put another way, in several embodiments the piezoelectric actuator does not overlap the ring resonator that it is configured to actuate. The horizontal (e.g. lateral) offset gap from the waveguide center can beneficially avoid overlap with the optical mode and can thereby allow low optical loss and high Q while realizing a large strain-optic effect and index and resonance shift.

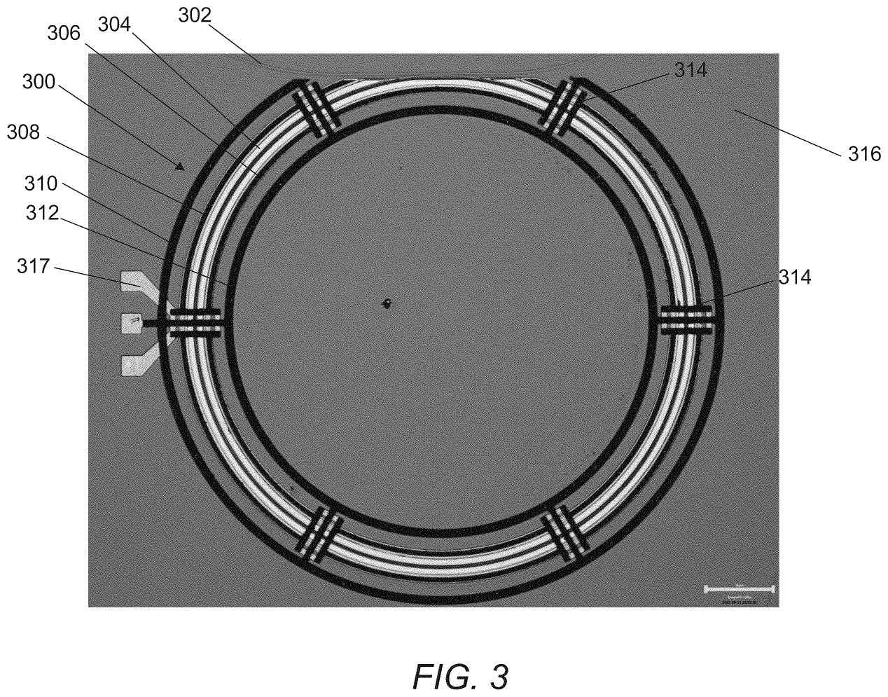

An example of a piezoelectric tunable ring resonator and a waveguide is conceptually illustrated in FIG. 3. The piezoelectric tunable ring resonator 300 can be a piezoelectric tunable ring resonator suitable for inclusion in a photonic molecule (e.g., photonic molecule 200). The piezoelectric tunable ring resonator 300 is shown in proximity to an optically coupled waveguide 302. The piezoelectric tunable ring resonator 300 can include a ring resonator 304. The ring resonator 304 can be located between a pair of piezoelectric actuators. The pair of piezoelectric actuators can include an inner piezoelectric actuator ring 306, and an outer piezoelectric actuator ring 308. Each of the piezoelectric actuator rings 306, 308 can be laterally offset from the ring resonator 304. The piezoelectric actuator rings 306, 308 can be connected to electrodes. Electrodes can include an inner electrode ring 310, and an outer electrode ring 312. The inner electrode ring and outer electrode ring 310, 312 can connect to the piezoelectric actuator rings at junctions 314. The piezoelectric tunable ring resonator 300 can be mounted in a cladding 316. The piezoelectric tunable ring resonator 300 can include a ground-signal-ground (GSG) pad 317. In several embodiments, a piezoelectric tunable ring resonator can have a radius of around 625 μm.

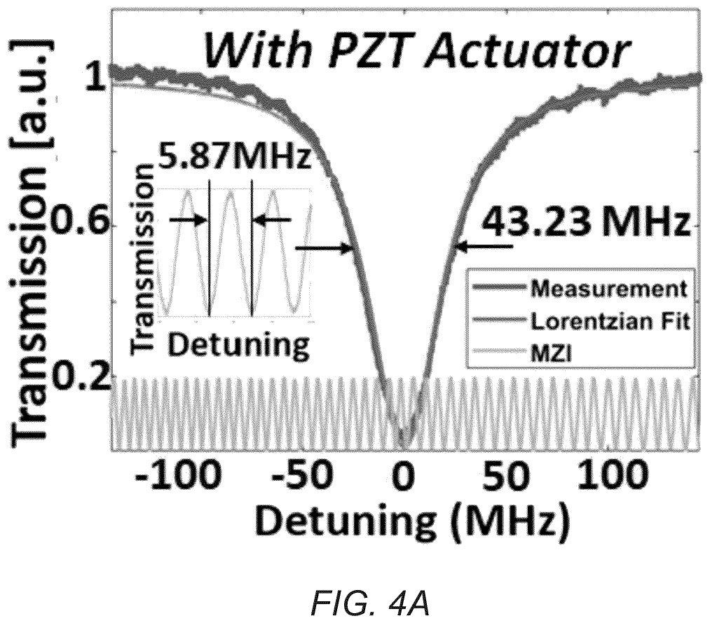

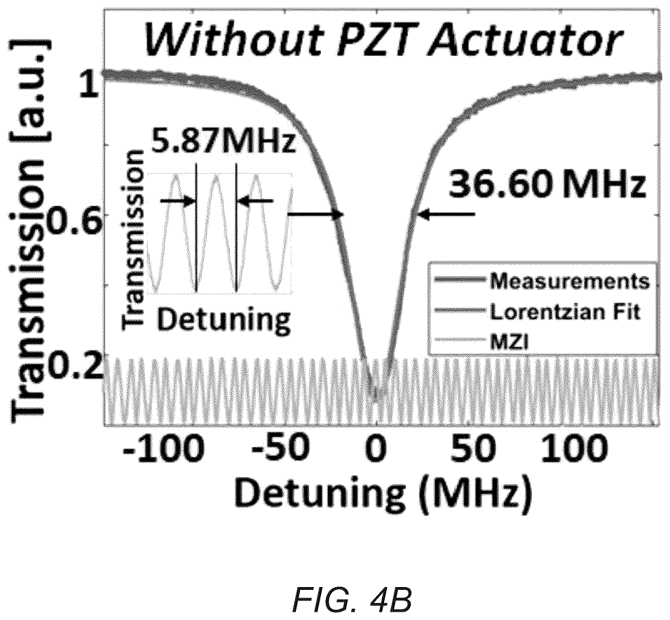

An example data set corresponding to a single ring resonator with PZT actuator is conceptually illustrated in FIG. 4A. The performance data shown in FIG. 4A corresponds to a single ring resonator can have a resonance FWHM of around 43.23 MHz at 1550 nm. This data can correspond to data obtained using a radio frequency calibrated unbalanced Mach-Zehnder interferometer (MZI). These measurements may correspond to an intrinsic Q of 8.11 million and loaded Q of 4.48 million, corresponding to a propagation loss of 3.3 dB/m.

An example data set corresponding to a single ring resonator without piezoelectric actuation is conceptually illustrated in FIG. 4B. This figure provides a comparison to the data in FIG. 4A. The ring resonator from which the data is generated in FIG. 4A and FIG. 4B are of the same geometry but FIG. 4 corresponds to a system without a piezoelectric actuation. The non-piezoelectric actuated ring resonator can have a resonance FWHM of 36.60 MHz corresponding to an intrinsic Q of 8.37 million and propagation loss of 3.19 dB/m. The loss is increased by only 3% relative to the PZT actuated ring resonator. This demonstrates that monolithically integrated PZT actuators maintain the properties of ultralow-waveguide loss and high Q.

### Tuning Photonic Molecules

In several embodiments, a Coupled Mode Theory (CMT) model can be used to simulate and predict supermode behavior, and/or to validate the resonance and splitting structure in photonic molecules. Simulation and prediction of these can enable programming of desired spectral properties for photonic molecules. Matrix approaches can be applied to model fully coupled three-ring photonic molecules that include the waveguide loss, bus-ring and ring-ring coupling coefficients, and effective mode index.

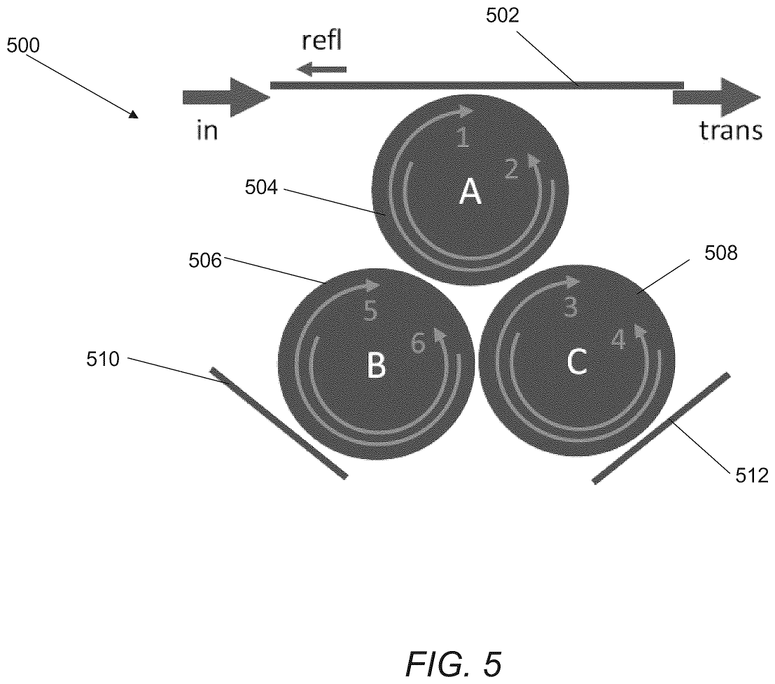

In many embodiments of the invention, each ring resonator of a photonic molecule can support two modes. A photonic molecule with three ring resonators and mode illustrations is conceptually illustrated in FIG. 5. A photonic molecule 500 includes a first waveguide 502 coupled to a first ring resonator 504. The first ring resonator 504 is coupled to a second ring resonator 506. The first ring resonator 504 and the second ring resonator 506 are both coupled to a third ring resonator 508. The second ring resonator 506 can be coupled to a second waveguide 510. The third ring resonator 508 can be coupled to a third waveguide 512. In several embodiments, each of the ring resonators can correspond to a first and second mode. The two modes can define the clockwise (CW) and the counterclockwise (CCW) coupled propagating fields. In various embodiments six supermodes can be supported due to the strong coupling between all three ring resonators in photonic molecules in accordance with embodiments of the invention. Mode splitting due to backscattering (e.g., backscattering caused by particles, defects and/or sidewall roughness) in each resonator, can be avoided due to a larger linewidth compared to scattering induced splitting in ring resonators as described herein in connection to various embodiments.

In many embodiments, each ring resonator of a photonic molecule can have two split states with a bonding orbital and an antibonding orbital. This can be analogized to the hydrogen molecule model. The split states can coherently add to generate supermodes.

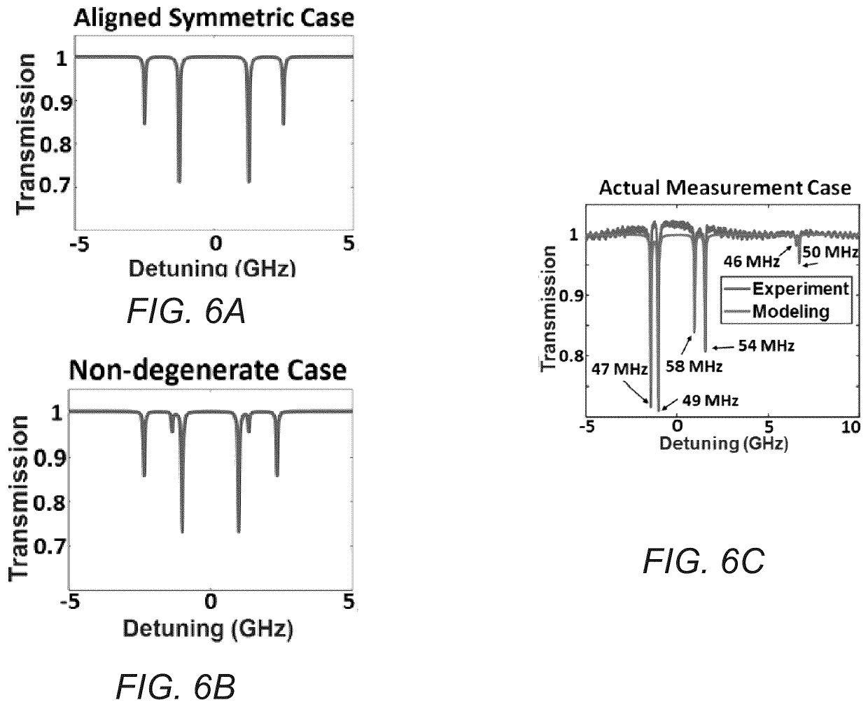

Transmission spectrum related to three mode-splitting cases related to the modes shown in FIG. 5 are conceptually illustrated in FIG. 6A through 6C. As shown in FIG. 6A, in theory when all resonators and waveguides have identical coupling parameters, the energy modes are degenerate with four supermodes. In FIG. 6A, the rightmost supermode has the highest energy level and the leftmost supermode the lowest energy level. The four supermodes are present in two degenerate pairs. As shown in FIG. 6B, in theory when symmetry is broken, due to for example, when the coupling strengths K between the resonators are non-uniform, the middle degenerate pairs split and mode degeneracy is lifted.

The measured transmission spectrum for input to output for one resonator of a photonic molecule is conceptually illustrated in FIG. 6C. The busses (e.g., waveguides) for the other two resonators serve as add/drop ports. In accordance with embodiments of the invention, fabrication variations among resonators and coupling can generally lead to asymmetric molecule energy. These variations can be seen in the experimental and modeled energy spectra in FIG. 6C. As can be seen in FIG. 6C, several embodiments can include photonic molecule with six supermodes with well-defined resonances with narrow linewidths. In the depicted example, a photonic molecule can have six supermodes with resonances and narrow linewidths of 47 MHz, 49 MHz, 58 MHz, 54 MHz, 46 MHz and 50 MHz, and corresponding loaded Q of 4.12 million, 3.95 million, 3.34 million, 3.58 million, 4.21 million, and 3.87 million, respectively. In FIG. 6C, the measured spectrum (blue) is in good agreement with a CMT matrix model fitting (orange) that incorporates measured cavity loss y and interring coupling coefficients K. Several embodiments of CMT matrix models can accurately design and predict the mode energy splitting. In accordance with embodiments of the invention, CMT matrix models can be used to calibrate photonic molecules. Calibration can be achieved by applying a current to PZT actuators of photonic molecules.

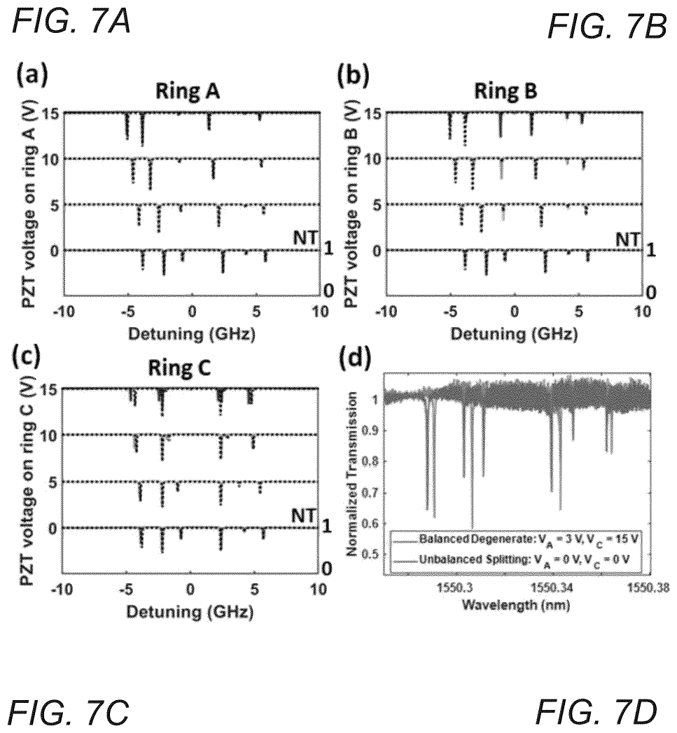

Photonic molecules, in accordance with many embodiments of the invention, can use supermode tuning. Supermode tuning can be applied by controlling the PZT DC bias for each ring resonator. Independent DC bias control for each ring resonator enables full control over supermode splitting and frequency location. In many embodiments, ring resonator supermode splitting and frequency location can be controlled based on voltage applied to PZT actuators. In this way, PZT actuated ring resonators can be tuned to allow a photonic molecule to achieve a balanced degenerate state. FIGS. 7A through 7C depict example transmission spectrums of ring resonators that together form a part of a photonic molecule when tuned by PZT actuators with applied DC bias. FIG. 7D depicts a corresponding frequency response of a photonic molecule with tuned and untuned ring resonators.

In FIGS. 7A through 7C, the colored lines indicate measured transmission spectra as the DC bias voltages applied to the PZT actuators are adjusted from 0 V to 15 V on each ring. The modeled behavior, given by the dashed lines, are in strong agreement with the measurements, yielding an important tool for designing, predicting, and accurately controlling the supermodes. By tuning two of the resonators at the same time, the symmetric degenerate case can be reached, as shown in FIG. 7D. In several embodiments, two resonators are simultaneously tuned to calibrate and balance the photonic molecule and/or tune the energy splitting. In accordance with several embodiments, PZT material has high resistivity resulting in a very low leakage current and power dissipation. In several embodiments, PZT actuators can have operate with a current of around 6 nA at 15-V bias, corresponding to around 90-nW electrical power consumption per actuator. The capacitance of the PZT actuator is measured to be approximately 600 pF in many embodiments, corresponding to a stored energy of 67 nJ at 15 V.

### Radiofrequency Modulation of Photonic Molecules

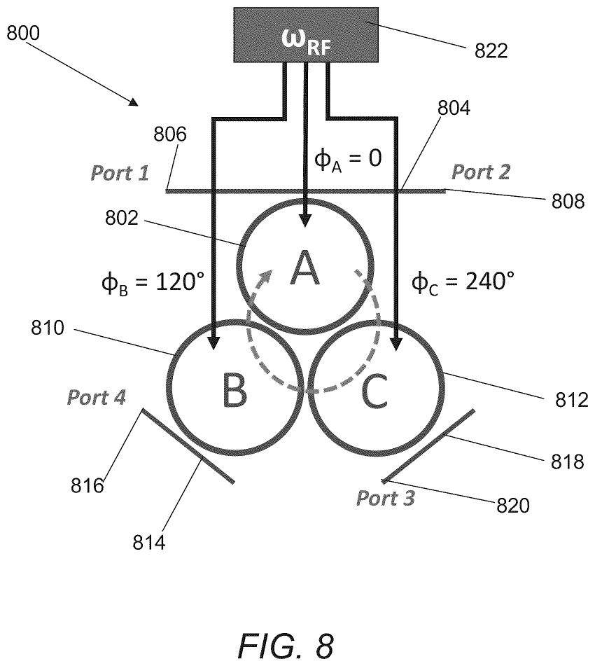

Radiofrequency modulation of photonic molecules can enable the use of photonic molecules as isolator and/or circulators. An example of a photonic molecule with radiofrequency driving is conceptually illustrated in FIG. 8. A photonic molecule system 800 can include a first piezoelectric tunable ring resonator 802 coupled to a first waveguide 804. The first waveguide 804 can have a first port 806 and a second port 808. The first piezoelectric tunable ring resonator 802 can be reciprocally coupled to a second piezoelectric tunable ring resonator 810 and a third piezoelectric tunable ring resonator 812. The second piezoelectric tunable ring resonator 810 and a third piezoelectric tunable ring resonator 812 can be coupled to each other. The second piezoelectric tunable ring resonator 810 can be further coupled to a second waveguide 814. The second waveguide 814 can have a fourth port 816. The third piezoelectric tunable ring resonator 812 can be further coupled to a third waveguide 818. The third waveguide 818 can have a third port 820. In accordance with many embodiments, the set of the piezoelectric tunable ring resonator and the coupled set of waveguides can form a photonic molecule. Each of the piezoelectric tunable ring resonators can, in accordance with several embodiments, include a ring resonator and a corresponding piezoelectric actuator that is configured to tune the ring resonator.

A photonic molecule system 800 can include a driving system 822. Driving systems can be power sources capable of providing modulating radiofrequency signals. The radiofrequency (RF) drive system 822 can be electrically connected to each of the first piezoelectric tunable ring resonator 802, the second piezoelectric tunable ring resonator 810, and the third piezoelectric tunable ring resonator 812. The RF drive system 822 can drive the tunable ring resonators with offset inputs. In this way, the RF drive system 822 can drive the first piezoelectric tunable ring resonator 802 with a 0-degree offset, can drive the second piezoelectric tunable ring resonator 810 with a 120-degree offset, and can drive the third piezoelectric tunable ring resonator 812 with a 240-degree offset. Driving operates cyclically thereby driving a rotating change in piezoelectric actuation.

In several embodiments, an RF drive can drive ring resonators with degree offset of driving based on the number of ring resonators in a photonic molecule. For instance, when a photonic molecule has three ring resonators, the driving frequency offset between each pair of ring resonators can be around 120-degrees. When a photonic molecule has four ring resonators, the driving frequency offset between each pair of ring resonators can be around 90-degrees. When a photonic molecule has five ring resonators, the driving frequency between each pair of ring resonators can be around 72-degrees. When a photonic molecule has six ring resonators, the driving frequency offset between each pair of ring resonators can be around 60-degrees. Expressed more generally, when a photonic molecule has a number of ring resonators, the driving frequency offset between each pair of ring resonators can be around 360 divided by the number of ring resonators.

The effect of applying the offset driving frequencies in a photonic molecule with three ring resonators can be summarized by the equations below.

ω₁(t)=ω₀+δωₘ cos(ωₘt)

ω₂(t)=ω₀+δωₘ cos(ωₘt+2π/3)

ω₃(t)=ω₀+δωₘ cos(ωₘt+4π/3)

δωₘ=ω₀Δεₘ/2ε

ω_{R}=ω±−Δω/2

ω_{L}=ω±+Δω/2

Δω=\sqrt{ωₘ²+δωₘ²}−ωₘ
ω₀: static value of the resonant frequency
δωₘ: modulation amplitude
ωₘ: modulation frequency
Δεₘ: permittivity modulation amplitude

When the modulating RF frequency is applied to photonic molecules with three ring resonators in accordance with many embodiments, the resulting effect of the device can be optical isolation and/or optical circulation. Optical isolation can be formed between the first port 806 and the second port 808. The effect of the optical isolation from first port 806 to the second port 808 is that all reflections are attenuated. Optical circulation can be effected for inputs to the second port 808, which can be output through the third port 820 and/or the fourth port 816. In accordance with embodiments of the invention, the piezoelectric actuators can receive a modulating radio frequency output, and based on this output can affect the ring resonator performance.

RF modulation (e.g., as described in connection with FIG. 8) applied to photonic molecules in accordance with embodiments of the invention can provides an effective electronic spin to the photonic molecule. This can beneficially relax the requirements of modulation intensity. Frequency splitting can, in various embodiments, be achieved by modulating the frequency of each resonator; by applying a uniform permittivity modulation with constant permittivity amplitude.

In accordance with several embodiments, waveguides can be ultra-low loss and ring resonators can be ultra-high Q. Ring resonators and waveguides can be operational from UV to Visible to Near-IR to mid-IR to IR. Materials used can include aluminum oxide, aluminum nitride, tantalum petoxide, and other wide bandgap materials to support low loss and high Q integration.

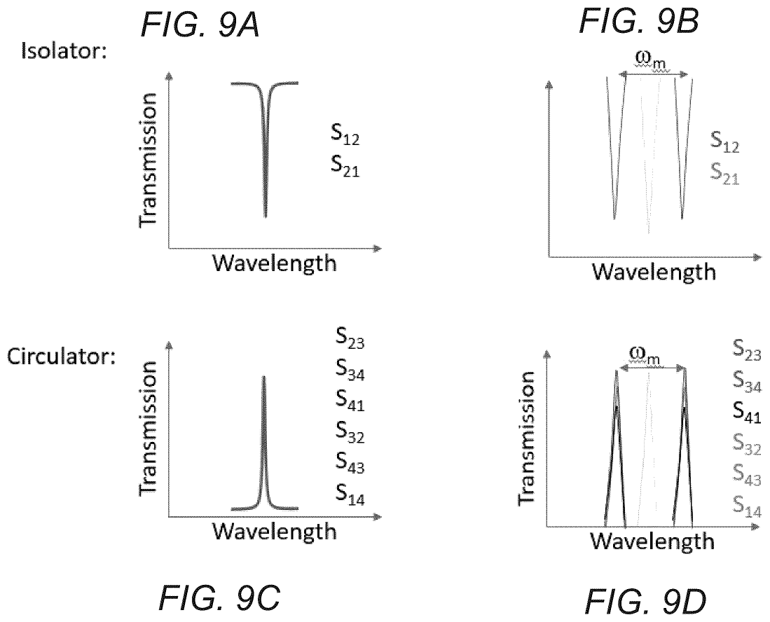

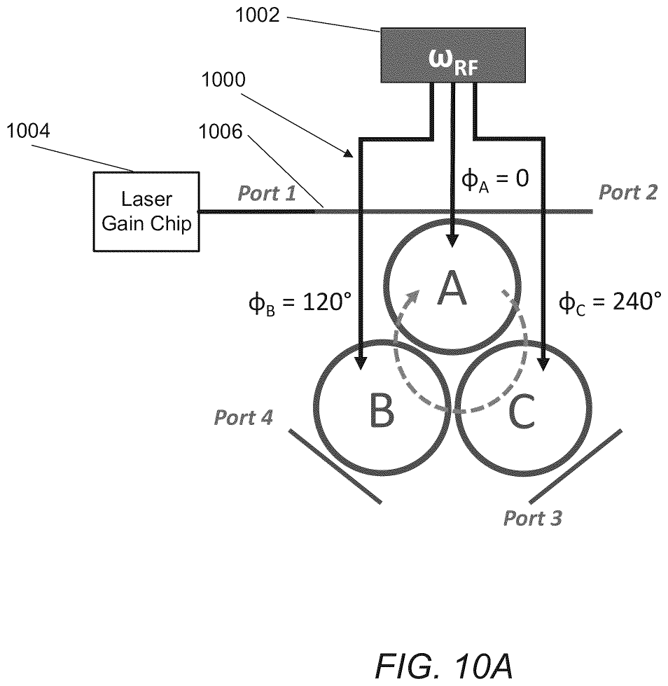

The effect of modulating RF frequency applied to a three-ring resonator photonic molecule are conceptually illustrated in FIG. 9A through FIG. 9D. FIG. 9A shows an example transmission spectrum for a first port to a second port and vice versa in an unforced condition (e.g., when no RF frequency modulation as described above is applied to the photonic molecule). As shown in FIG. 9A, In the unforced condition the frequency response is the same in both directions. However, when the radiofrequency modulation is applied, as shown in FIG. 9B, the frequency response from the first port to the second port splits. In contrast the frequency response from the second port to the first port does not split. Thus, the forced photonic molecule can function as an isolator.

Similarly, As shown in FIG. 9C, In the unforced condition the frequency response is the same in all directions through the photonic molecule. However, when the radiofrequency modulation is applied, as shown in FIG. 9D, the frequency response from the second port to the third port, the third port to the fourth port, and the fourth port to the first port splits. Thus, the forced photonic molecule can function as a circulator.

In accordance with many embodiments of the invention, radiofrequency (RF) modulation can be applied to all piezoelectric actuators to produce a spatio-temporal modulation of the corresponding ring resonators that is decoupled from physical dimensions of each ring resonator. Piezoelectric actuators can correspond, in several embodiments, to ring resonators on a one-to-one basis.

In many embodiments, RF forcing of photonic molecules can be performed in addition to DC biasing. In several embodiments, DC biasing can be performed using piezoelectric actuators, heaters (e.g., platinum heaters), and/or other methods.

While the depicted embodiments herein relate primarily to photonic molecules including three sets of piezoelectric tunable ring resonators and corresponding waveguide, it is noted that similar systems with more than three sets of piezoelectric tunable ring resonators and corresponding waveguide are possible and this disclosure is not intended to be limited to just systems with three sets of piezoelectric tunable ring resonators. In some embodiments, a photonic molecule can include more than three sets of piezoelectric tunable ring resonator and corresponding waveguide. In such cases, the layout of the ring resonators will still be symmetric. Furthermore, the ring resonators will be positioned such that each is coupled to at least two other ring resonators in the photonic molecule. In this way a photonic molecule can have three or more ring resonators, associated actuators, and associated waveguides.

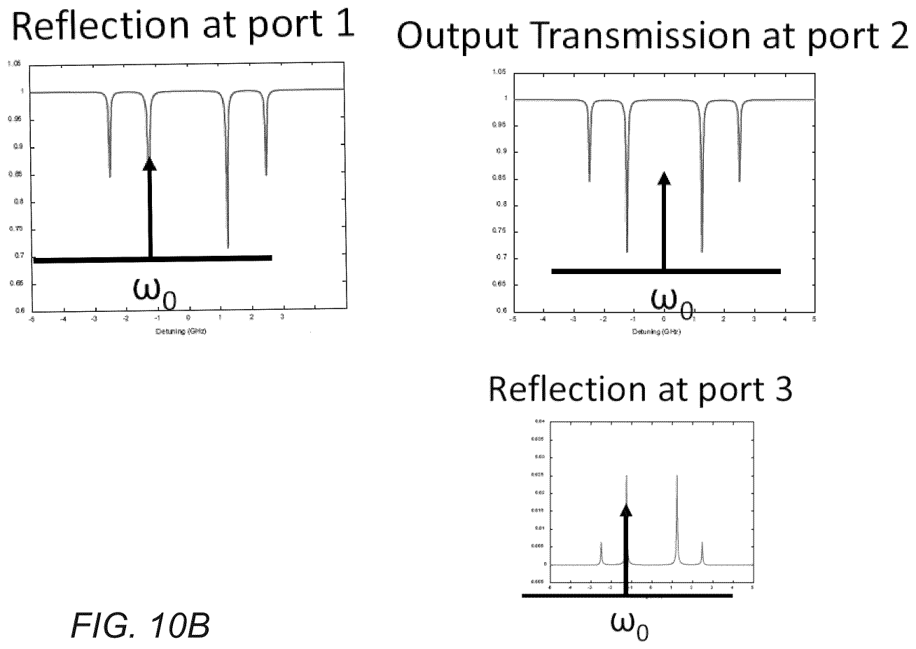

In many embodiments a photonic molecule with RF modulation can be used in a self-isolating laser. An example of a self-isolating laser is conceptually illustrated in FIG. 10A through 10B. A photonic molecule system 1000 can be similar in various aspects to the photonic molecule system 800 described elsewhere herein. The photonic molecule system 1000 can include an RF driving system 1002. A laser gain chip 1004 can be connected to a first port 1006. The photonic molecule system 1000 with RF driving can act as an isolator for the laser gain chip to form a self-isolating laser.

As illustrated in FIG. 10B, the output transmission pattern at port 2 and the reflection at port 1 of the isolator may include four distinct peaks. Each of the isolator rings can include two modes which would naturally add up to six peaks. However, in accordance with many embodiments, the piezoelectric actuators may be controlled through the RF drive to optimize the operation to allow two of the peaks overlap which would allow a strong optical reflection at the desired carrier frequency ω0 of the laser gain chip. Thus, the reflection at port 1 is high at the ω0. When the reflection at port 1 is high at the ω0, the outside noise may be prevented from entering the laser cavity. Further, the RF signal may drive the piezoelectric actuators to create a separate transmission characteristic at port 2 such that the ω0 is outputted rather than reflected. These conditions are optimal for an isolator which reflects outside noise from the laser cavity while transmitting the light from the laser. Further, the isolator may act as a leaky mirror by circulating the light within the laser cavity. As illustrated, the reflection at port 3 may be high at the ω0. Thus, at port 3, the ω0 may be substantially reflected which would make the isolator act as a mirror. The RF drive may switch through each of the rings such that at some times the isolator act as a mirror to the light from the laser gain chip (at port 3) and other times it transmits the light from the laser gain chip (at port 2) and reflects outside noise from entering Port 1.

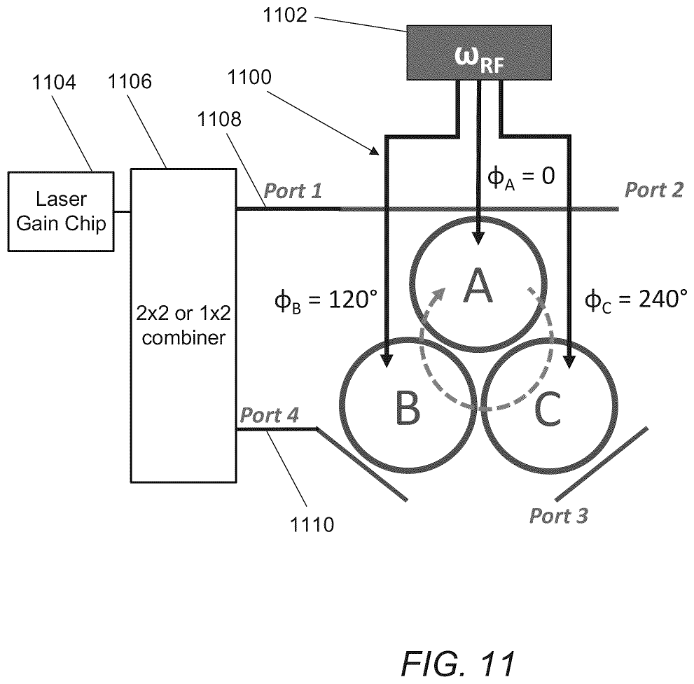

An example of a self-isolating laser incorporating a combiner is conceptually illustrated in FIG. 11. A photonic molecule system 1100 can be similar in various aspects to the photonic molecule system 800 described elsewhere herein. The photonic molecule system 1100 can include an RF driving system 1102. A laser gain chip 1104 can be connected to a combiner 1106. Suitable combiners can include at least 2×2 combiners and 1×2 combiners. The combiner 1106 can be connected to a first port 1108 and to a second port 1110. The photonic molecule system 1000 with RF driving can act as an isolator for the laser gain chip to form a self-isolating laser.

In several embodiments, laser gain chips can be connected to a 2×2 optical coupler which is connected between the laser gain material and the optical isolator. A first port of the 2×2 optical coupler may be connected to port 1 and a second port of the 2×2 optical coupler may be connected to port 3 of the optical isolator. Thus, the circulated light from Port 3 of the isolator may be routed back to the laser cavity while light may be transmitted out to Port 1 of the isolator. This configuration can enable the isolator to isolate the laser cavity from outside optical reflections or noise while acting as a leaky mirror to the light from the laser cavity which may act as the laser output.

In several embodiments, the disclosed isolator may be used to realize a tunable laser. Such an integrated tunable laser may be utilized in various applications such as quantum, metrology, atomic navigation, and timekeeping, and other industries. The disclosed isolator can also be used in a self-injection locked laser configuration to realize the low linewidth benefits and other benefits of self-injection locking. The tunable laser includes non-magnetic, ultra-low power consumption optical isolation to the chip-scale, for applications that can span the UV through visible through the near-IR through the IR.

Various embodiments of this disclosure relate to a fully-coupled three resonator photonic molecule. The three ring resonator photonic molecule may be utilized as an optical isolator as discussed above. In several embodiments, the photonic molecule includes silicon nitride resonators with measured intrinsic high Q of 8.11×10⁶. Each resonator can be controlled using monolithically integrated 90 nW low-power dissipation PZT actuation, with a linear tuning coefficient of 160 MHz/V and/or may be modulated at frequencies of 10 MHz, 20 MHz and higher to the 100s of MHz and GHz in accordance with embodiments of the embodiments. The choice of modulation frequency may be flexible and determines the isolation, an advantage over other spatio-temporal designs that do not allow arbitrary modulation frequencies. The devices may be fabricated with a CMOS-compatible stress-optic actuator (e.g. PZT) process without utilizing complex processes like under-cut or released and suspended structures.

In some embodiments, A matrix coupled photonic molecule model may be utilized to simulate the behavior of six supermodes. Supermode evolution and resonance splitting may be modeled with the simulated and measured responses in good agreement in several embodiments. The photonic molecule can be tuned into the degenerate and the non-degenerate states by adjusting the bias voltages, allowing compensation for fabrication variations between the rings and coupling gaps. In many embodiments, by changing coupling strengths between the resonators with the piezo actuation, the mode-splitting, peak narrowing, and extinction ratio can be controlled, leading to spectral engineering applications where low-power and fast mode-splitting modulation is advantageous. The large splitting and small resonance shift may be simultaneously achieved in this system which can, in accordance with embodiments of the invention be utilized as a potential control mechanism to widely tunable and resonance-shift-free mode splitting.

While specific methods and/or systems for photonic molecules are described above, any of a variety of methods and/or systems can be utilized as a photonic molecule as appropriate to the requirements of specific applications. In certain embodiments, steps and/or components may be performed and/or configured in any order, sequence, and/or configuration not limited to the order, sequence and/or configuration shown and described. In a number of embodiments, some of the above steps may be executed or performed substantially simultaneously where appropriate or in parallel to reduce latency and processing times. In some embodiments, one or more of the above steps and/or components can be rearranged or omitted. Although the above embodiments of the invention are described in reference to a photonic molecule, the techniques disclosed herein may be used in any type of integrated optical system. The techniques disclosed herein may be used within any of the ring resonators, waveguides, photonic molecules and/or other components and/or systems as described herein.

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

What is claimed is:

1. A photonic molecule configured as a programmable tunable dispersion engineering system, the photonic molecule comprising:
a first ring resonator optically coupled to a first waveguide, wherein the first ring resonator is tunable by a first piezoelectric actuator;
a second ring resonator optically coupled to a second waveguide, wherein the second ring resonator is tunable by a second piezoelectric actuator; and
a third ring resonator optically coupled to a third waveguide, wherein the third ring resonator is tunable by a third piezoelectric actuator;
wherein the third ring resonator is optically coupled to the first ring resonator and the second ring resonator, wherein the second ring resonator is optically coupled to the first ring resonator and the first ring resonator, and wherein the first ring resonator is optically coupled to the second ring resonator and the third ring resonator.

2. The photonic molecule of claim 1, wherein each of the first, second, and third ring resonators are independently controllable by separately applying a first voltage to the first piezoelectric actuator, a second voltage to the second piezoelectric actuator and a third voltage to the third piezoelectric actuator.

3. The photonic molecule of claim 1, wherein at least one of the first, second, and third piezoelectric actuators is a lead zirconate titanate stress-optic actuator.

4. The photonic molecule of claim 1, wherein the first, second, and third ring resonators are positioned at a regular spacing of around 120 degrees.

5. The photonic molecule of claim 1, wherein the first piezoelectric actuator, second piezoelectric actuator, and third piezoelectric actuator all allow DC bias resonance tuning of the first ring resonator, second ring resonator, and third ring resonator respectively.

6. The photonic molecule of claim 1, wherein the first piezoelectric actuator allows radio frequency modulation of the first ring resonator, the second piezoelectric actuator allows radiofrequency modulation of the second ring resonator, and the first piezoelectric actuator allows radiofrequency modulation of the third ring resonator.

7. The photonic molecule of claim 6, wherein there is a fixed phase relationship between the modulation of the first ring resonator, the second ring resonator, and the third ring resonator.

8. The photonic molecule of claim 7, wherein the fixed phase relationship is an around 120 degree phase shift between each pair of ring resonators.

9. The photonic molecule of claim 1, wherein the resonators have a Q greater than around 8 million and the waveguides are ultra-low loss.

10. The photonic molecule of claim 1, wherein each of the ring resonators are equally spaced from each other, and wherein the spacing between each waveguide and each ring resonator is a same amount.

11. The photonic molecule of claim 1, wherein a radiofrequency (RF) modulation can be applied to all three piezoelectric actuators to produce a spatio-temporal modulation of the ring resonators that is decoupled from physical dimensions of each ring resonator.

12. A non-magnetic ultra-low loss waveguide integrated optical isolator and circulator, the optical isolator circulator comprising:
a set of ring resonators, wherein each ring resonator from the set of ring resonators is optically coupled to a waveguide and each ring resonator is optically coupled to at least two other ring resonators from the set of ring resonators, and wherein the set of ring resonators comprises at least a first ring resonator, a second ring resonator, and a third ring resonator;
a set of piezoelectric actuators, wherein each ring resonator in the set of ring resonators corresponds to a piezoelectric actuator from the set of piezoelectric actuators on a one-to-on basis, and wherein the set of piezoelectric actuators is configured to tune each of the ring resonators from the set of ring resonators independently; and
a signal source electrically connected to each piezoelectric actuator in the set of piezoelectric actuators, the signal source configured to provide a modulating radio frequency input to each piezoelectric actuator in the set of piezoelectric actuators such that a first piezoelectric actuator receives a first modulating radio frequency input, the second piezoelectric actuator receives a second modulating radio frequency input, and the third piezoelectric actuator receives a third modulating radio frequency input;
wherein the second modulating radio frequency input is offset from the first modulating radio frequency input by a first amount, the third modulating radio frequency input is offset from the first modulating radio frequency by a second amount, and the second amount is around double the first amount; and
wherein the first amount is equal to around 360 degrees divided by a total number of ring resonators in the set of ring resonators.

13. The optical isolator of claim 12, wherein the ring resonators are positioned at a regular spacing equal to around 360 degrees divided by the total number of ring resonators in the set of ring resonators.

14. The optical isolator of claim 12, wherein each of the ring resonators is configured to be DC bias resonance tuned.

15. The optical isolator of claim 14, wherein the piezoelectric actuators are zirconate titanate stress-optic actuators.

16. The optical isolator of claim 12, wherein the first, second, and third ring resonators are positioned at a regular spacing of around 120 degrees.

17. The optical isolator of claim 14, wherein a radiofrequency (RF) modulation applied to the piezoelectric actuators produces a spatio-temporal modulation of the ring resonators that is decoupled from physical dimensions of each ring resonator.

18. The optical isolator of claim 12, wherein the first waveguide, the first ring resonator, the second ring resonator, the third ring resonator, and the second waveguide are mounted in a fully planar platform.

19. A self-isolating laser, the self-isolating laser comprising:
a laser source connected to a first port on a first waveguide, the first waveguide comprising the first port and a second port;
a first ring resonator optically coupled to the first waveguide, wherein the first ring resonator is tunable by a first piezoelectric actuator;
a second ring resonator optically coupled to a second waveguide, wherein the second ring resonator is tunable by a second piezoelectric actuator; and
a third ring resonator optically coupled to a third waveguide, wherein the third ring resonator is tunable by a third piezoelectric actuator;
wherein the third ring resonator is optically coupled to the first ring resonator and the second ring resonator, wherein the second ring resonator is optically coupled to the first ring resonator and the first ring resonator, and wherein the first ring resonator is optically coupled to the second ring resonator and the third ring resonator.

20. The self-isolating laser of claim 19, wherein the first ring resonator, second ring resonator, and third ring resonator are modulated by a radiofrequency and there is a fixed phase relationship between the modulation of the first ring resonator, the second ring resonator, and the third ring resonator.
